(19) United States
(12) Patent Application Publication
(10) Pub. No.: US 2002/0153107 A1
(43) Pub. Date: Oct. 24, 2002

(54) METHOD FOR USE OF RECYCLED LIGNOCELLULOSIC COMPOSITE MATERIALS

(76) Inventor: EDMONE ROFFAEL, BRAUNSCHWEIG (DE)

Correspondence Address: LADAS & PARRY, 26 WEST 61ST STREET, NEW YORK, NY, 10023

(21) Appl. No.: 09/319,233

(22) PCT Filed: Dec. 1, 1997
(86) PCT No.: PCT/GR97/00041

(30) Foreign Application Priority Data
Dec. 2, 1996 (GB) 9625068.3

(51) Int. Cl. B27N 1/00; D21B 1/08; D21B 1/32; D21C 5/02; B27N 3/00; B27N 3/28

(52) U.S. Cl. 162/4; 162/7; 162/8; 428/537.1; 428/537.5

(57) ABSTRACT

Materials for use in forming composite products are prepared from recycled composite materials and treated by hydrothermal treatment at 40 ° C. to 120 ° C. along with or followed by high shear treatment. The process enables the use of recycled materials not hitherto usable successfully and it is possible to form composite products with less or no additional bonding resin.

This invention relates to the production of lignocellulosic particles or fibres and formation of composite materials therefrom. It particularly relates to the production of such particles or fibres from recycled composite materials and bonding with synthetic binders into composite materials.

Never before has there been so much demand placed on the world's fibre resource. World-wide economic growth and development have created needs for converted forest products. Congruently, the energy needs of developing countries are generating increasing demands for fuelwood, which now represents 50% of all wood fibre consumption. At the same time, global fibre production systems, in total, are demonstrating the capability to meet these demands. Regardless of tremendous pressures for fibre resource, there is not a global fibre shortage or crisis. However, there are some serious local and regional fibre shortages and resource management conflicts that will play a critical role in the immediate and long-term future.

Composite materials like particleboards, medium and high density fibreboards are mainly made from wood using binders like acid curing urea-formaldehyde resins, alkaline curing phenol-formaldehyde resins, as well as polyisocyanate adhesives. Medium density fibreboards are fibreboards prepared using a dry technique as follows: Wood or any other lignocellulosic materials are subjected to thermomechanical pulping at a temperature of about 160 to 180° C., then mixed with the resin and dried. Thereafter ats are formed from the fibres and pressed to form fibreboards. Particleboards, on the other hand, can be prepared from chips which are mixed with resins and the S glued particles are spread to mats and pressed at high temperature to particleboards.

Medium density fibreboards cover a wide range of densities between 0.6 and 0.8g/cm³ depending on their thickness and field of application. Boards with density lower than 0.5g/cm³ are not common, but can be produced. The quality required depends on the field of application of the board andi ts th ickness:

| Thickness | For >6-12 mm | For >12-19 mm |
|---|---|---|
| Internal Bond (IB), N/mm² | 0.65 | 0.60 |
| Bending strength (MOR), N/mm² | 35 | 30 |

Particleboards are prepared in the density range of 0.4 to 0.85g/cm³ depending upon their field of application and thickness. Boards with density lower than 0.5g/cm³ are low-density boards, between 0.5 and 0.7g/cm³ are medium density, and greater than 0.7g/cm³ are high density boards. Also, in the case of particleboards, the requirements depend on the field of application and thickness of the boards:

| Thickness | For >6-13 mm | For >13-20 mm |
|---|---|---|
| Internal Bond (IB), N/mm² | 0.4 | 0.35 |
| Bending strength (MOR), N/mm² | 17 | 15 |

The conventional process for making composite panel products from lignocellulosic materials relies exclusively on synthetic resin binders for bonding. Since synthetic resins, such as phenol- and urea-formaldehyde, are expensive, they normally constitute a large portion of production cost for the conventional panel products, such as particleboard, waferboard and medium density fibreboard.

This is especially true in the case of agricultural residues. Because of their.physical nature, a relatively high content of resin binders is required for manufacturing, thus resulting in an expensive panel product. Therefore, increased attention has been paid to induce bonding between lingocellulosic surfaces by creating surface-to-surface bonds without the use of any adhesives.

Thus there is a need to eccnnni se on mounts of bonding agent employed in composite materials for both economic reasons and to minimise possible pollution.

Literature which is relevant to this issue is:

Brink, D.L.; Collett, B.M.; Pohlman, A.A.; Wong, A.F.; Philippou, J.; In wood Technology; Chemical Aspects, Goldstein, I.S., Ed.; ACS Symposium Series, no. 43; ACS Washington, D.C., 1977, p. 169.

Brink, D.L.; Johns, E.E.; Zaverin, E.; Kuo, M.L.; Nguyen, T.; Layton, D.; Wong, A.; Bimbach, M.; Merriman, M.M.; Breiner, T.; Grozdits, G.; Wu, K.T.; University of California, Forest Products Laboratory, Techn. Rep. 36.01.108, 1977-80.

Collett, B.M.: Thesis, University of California, Berkeley, 1973

Linzell, H.K.; US Patent 2,388,487, 1945

Philippou, J.L.; Wood Chem. Technol., 1981, 1, 199

Philippou; J.L.; Johns, W.E.; Nguyen, T.; Holzforschung, 1982.36,37

Philippou, J.L.; Johns, W.E. Zavarin, E.; Nguyen, T.; Forest Products Journal, 1982, 32, 3, 27

Philippou, J.L.; Zavarin, E.; Johns, W.E. Nguyen T.; Forest Products Journal, 1982, 32 5 551

Pohlman, A.A.; M.S. disertation, Berkeley, California, 1874

Roffael, E.; Dix, B.; Lighin und Ligninsulfonate in non-conventional bonding—an overview. Holz als Roh—und Werkstoff 49, 199 205

Roffael, E.; Schaller, K.; ElnfiuB thermischer Behandiuing auf Cellulose. Holz als Roh—und Werkstoff 29, 275-278

Schorning, P.; Roffael, E.; Stegmann, G.; Holz als Roh—und Werkstoff, 1972,30, 253

Troughton, G.E,; Chow, S.-Z.; Wood Science, 1971, 3, 129

First attempts to create covalent bonds between two surfaces go back to 1945, when Linzell patented a process for making fibre products by compressing and heating a mixture of lignocellulosic fibres and ferric compounds as oxidising agent (U.S. Pat. No. US-A-2,388,487). Stafko and Zavarin (U.S. Pat. No. US-A-4,007,312) used oxidative coupling to include wood-to-wood bonds (Philippou et al., 1981, 1982).

Covalent bonding of wood by means of bifunctional molecules appears to offer additional possibilities through more efficient bridging of the gaps between the wood surfaces, i.e., the wood surfaces do not need to be as near as about one bond length as in the case of direct bonding, but could be separated by gaps of several bond lengths.

Schorning et al. (1972) attempted to make particle boards by using ethylenediamine and 1,6-hexanediamine as bonding agents. These amines are known to interact with wood surface by condensation with ligin. Addition of 15% of ethylenediamine imparted noticeable strength to particle board, which was still insufficient for commercial considerations. 1,6-Hexanediamine was more efficient with the particleboard having a bending strength of 6,5 N/mm² at 7% addition (density, 0.85 g/cm², pressing at 14° C. for 12 min.); however, the water resistance was low. The better results obtained with 1,6-hexanediamine can be explained by the more efficient gap bridging ability of the amine. Here the internal bond strength was 0.3 N/mm² at 7% addition and the bending strength 16.6 N/mm². Here again, the thickness swelling was more about 100%.

Collett (1970) and Brink (1977) attempted to improve the method of Schorning et al. by preoxidizing wood particles either with HN03 in the presence of oxygen, or with nitrogen oxides in the presence of oxygen at controlled time and temperature conditions. The bifunctional agents 1,6-hexanediamine, ethylenadiamine, phenylenediamine, ethylene glycol, and 1,6-hexanediol as well as the monofunctional ammonia were used. Overall, diamines gave the best IB values, followed by ammonia, and glycols performed poorly. As with Schorning et al. 1,6-hexanediamine proved to be better than ethylenediamine. At densities of 0.81-0.88 g/cm³, the 10% dry wood basis 1,6- hexanediamine board gave Internal Bond (IB) values (measured in Kp/cm²) appreciably above the values reached by Schorning et al., which demonstrated the value of preoxidation. The bond properties were still very low compared with technical products. Increased preoxidation with nitrous gasses or higher amine levels resulted in less swelling and an increase in IB. The results suggest the formation of water-resistant covalent bonds. Formation of amide and ester linkages was used to explain the bond formation (U.S. Pat. No. US-A-3,900,334).

Bifunctional molecules were studied (Brink 1977, Pohiman, 1974), including maleic anhydride, maleic acid, succinic anhydride, and saccharinic acid as cross-linking agents, in combination with surface activators including HC1, hydrobromic acid, perchloric acid, H₂SO₄, ferric chloride, zinc chloride, ferric nitrate, oxalic acid, and formic acid. Although superior in water resistance, overall the board was appreciably inferior to phenol- formaldehyde board. Extraction experiments indicated that between 97 and 99% of monomers interacted with surface.

Under aggressive acidic conditions, carbohydrates, especially hermicelluloses, undergo degradation leading to formation of monomeric sugars, which can undergo further transformation into furfural and furfural derivatives. Thus monomer sugars can crosslink wood surfaces.

In the EP 0,161,768 Bl a process is described, wherein lignocellulosic materials containing more than 10% hemicellulosics are converted to reconstituted composite materials by packing the lignocellulosic material into a vessel and applying high pressure steam to heat a cellulosic material. Hemicelluloses degrade under the action of the hydrothermal treatment. Thereafter, the lignocellulosic materials can be pressed to a reconstituted panel without adding any further common adhesives as urea- formaldehyde or .phenol-formaldehyde resins or by adding less than might usually be added having regard to the fibrous or particulate content. However, this process is applicable only on lignocellulosics with a relatively high content of hemicelluloses.

Many patent applications were devoted to the adhesive properties of hemicellulosic substances derived from wood or any other lignocellulosic material. In the U.S. Pat. No. US-A-2,224,135 the water soluble compounds of the hardboard manufacturing process were separated and traded as adhesive. However, the adhesive bonds created by hemicelluloses and their degradation products are of poor stability and had limited commercial applications.

In the U.S. Pat. No. US-A-5,017,319 a method is described for creating wood-to-wood bonds by a three step process: In the first step the wood material is hydrolysed by the action of steam. In the second step the lignocellulosic raw material is maintained in contact with the released hemicelluloses for a time sufficient for the non-catalytic decomposition of the hemicelluloses to low molecular weight carbohydrates. In the last step the lignocellulosic material is pressed without any washing of the degradation product. However, this method requires a high energy treatment and a special apparatus for carrying out the steaming, process.

Another concept to enhance wood-to-wood bonding is to activate the surface of wood particles or wood veneers by several mechanisms including oxidation, free radical formation, and identification. A review on the literature on this subject has been published by Roffael and Dix (1990). However, all trials to enhance bonding strength were traditionally, economically unfavourable. Therefore, no indstrial Piterost has been ciirected, towards this method.

In our applications UK-9607566.8 and a corresponding US application both filed on Apr. 12th, 1996 and our PCT application filed Apr. 10th, 1997 there is described a method of improving the bondability of annual plant fibres by subjecting such plant fibres to water or steam treatment (hydrothermal treatment) at from 40 to 120° C. accompanied by or followed by a treatment with high shear forces which defibrate the plant fibres. The resulting treated fibres can be formed into composites for example fibreboard or particleboard by bonding with synthetic resins. The extent of the high shear treatment required may depend on the type of composite to be produced. The composites are bonded with synthetic resins such as urea-formaldehyde resins, melamine resins or polyisocyanate resins.

Optionally the process can be improved by treatment with a dilute alkaline solution for example a solution of sodium hydroxide. As stated the process of water or steam treatment/high shear treatment can be carried out simultaneously on in sequence. The mixing with bonding resin can be carried out in the high shear machine.

It has now been found that this process of hydrothermal treatment/high shear treatment can be used to convert waste composite board materials for example particle—and fibreboards i.e. composite materials bonded with synthetic resins into products for manufacture of composite products. In one embodiment of the invention the waste or recycled composite product will be bonded into a composite material with addition of less bonding resin than would normally be required. Thus the process of the invention will result in saving in resin.

While fibrous/particulate lignocellulosic materials have been treated by water/steam treatments with simultaneous or subsequent high shear treatment, use of these lower temperatures has only been in the context of treatments for the manufacture of paper or similar materials and there has been no suggestion that this treatment when applied to lignocellulosic materials in the context of producing composites would enhance the fibrous or particulate material for forming into composite material. The process of the invention is also to be distinguished from producing composite materials from lignocellulosic materials in which there is an initial treatment at high temperature of at least 150° C., usually 150° C. to 170° C. followed by defibration.

Thus DE-A-3609506 relates to a treatment of raw wood chips with steam in which a glue mix is added under specific conditions. High pressure steam is employed.

Similar art is W091/12367, W093/25358, EP0664191A1, US-A- 3843431, DE4211888A1, EP0292584A1 and EP0373725.

Accordingly to the invention, therefore, there is provided a method for producing fibrous or particulate material for manufacture of composite materials from recycled composite materiaL wherein the recycled material is subjected to treatment with water or steam at 400 to 120° C. and simultaneously or subsequently subjected to a high shear treatment.

The product can thereafter be formed into a composite material. The invention also relates to a lignocellulosic material which has been subjected to such water/steam treatment and high shear treatment and is in a form suitable for bonding into a composite. The initial material is thus fibrous or particulate material derived from recycled (waste) composite materials.

Thus one can prepare fibres with high self-bonding properties by hydrothermomechanical treatment of waste particleboards or of waste fibreboards bonded with aminoplastic resins like urea-formaldehyde resins, melamine urea-formaldehyde resins or any other hydrolysable resin.

This result was unexpected due to the following reasons:

1. Lignocellulosics, like waste particleboards had been thermally treated under acidic conditions during the drying and the pressing process. Under such conditions lignocelluloses experience a so called “irreversible hornification” (Roffael and Schaller, 1971). Due to such process the ability of lignocellulosics to reswell and rebond is considerably decrease.

2. The process of hornification is enhanced in the presence of acidic medium created by the hardeners in the particleboard.

It may be possible to form the composite product with less or without the use of any additional binder.

The invention also includes the process of forming the hydrothermal/shear treated material into a composite material with bonding by added bonding resin or, possibly with less bonding material or without addition of bonding resin.

Preferably the process involves the treatment of recycled composite materials at from 50° C. to 120° C.

The term recycled composite materials covers all materials which comprise fibres or particles of lignocellulosic materials which have been bonded with synthetic resins.

The final composite materials can be panel products, reconstituted lumber products and moulded articles including particleboard, waferboard and fibreboard.

In a specific embodiment of the present invention the invention relates to a process of converting such recycled lignocellulosic materials into composite products such as panel products etc.

This aspect of the invention relates to a process of converting waste particle—and fibreboards into composite products. This invention particularly relates to a process of converting such recycled lignocellulosic materials into composite products such as panel products, reconstituted lumber and moulded articles, possibly without the use of any additional adhesive binders which are an essential part of the conventional dry process of manufacturing composite products, such as wood-based particleboard, waf erboard and medium density fibreboard.

The hydrothermomechanical treatment can be carried out in any high shear device like a twin screw extruder or attrition mill. The treatment according to the invention is thus conducted in a high-shear machine under conditions that result in disruption and disintegration of recycled material to increase its accessibility towards bonding. The rate of extrusion depends upon the conditions used and also the type of the machine applied and can differ from 5kg/h to 20t/h. Use of BIVIS extruder in accordance with a preferred embodiment of the invention provides the requisite high-shear treatment. Other high-shear machines, which can be used are e.g. Ultra Turrax mixers, which through their mechanical design are able to disrupt the morphological structure of recycled material.

“The shear forces to be applied depend upon the raw material used sand on whether or not chemicals are added to the substrate”. The hydrothermomechanical treatment can be carried out at a temperature of from 50° C. to 120° C. Moreover, chemicals like dilute acids, dilute alkali or even chemicals with high affinity to lignin like sodium suiphite, sulphur dioxide can be added to enhance defibration of waste lignocellulosic material. Thus the properties of the boards made from recycled material can be further improved if the material is treated with various chemicals. These reagents can be used either alone or in combinations and include metal hydroxides, such as lithium, sodium, potassium, magnesium, aluminium hydroxide etc., organic and inorganic acids, such as phosphoric, hydrochloric, sulphuric, formic, acetic acid etc.; salts, such as sodium—sulphate, sodium sulphite, sodium tetraborate etc., oxides, such as aluminium oxide etc, various amines and urea, ammonia, as well as ammonium salts. The aforesaid reagents are used in the form of water solution or suspension in quantities between 0.01-10% based on dry material.

The chemical treatment and the defibration can be carried out in one step, by subjecting the recycled material to a stream of water during the high shear stage, containing the amount of chemical needed to upgrade the properties of the amino resin bonded boards. After the defibration, the fibres produced can be dried using conventional dryers used in particleboard factories, e.g. a drum dryer or a tube dryer, like that used in medium density fibreboard mills. From then onwards, the dried fibres follow the conventional procedure as for the production of particleboard or medium density fibreboard. However, the addition of such chemicals is not obligatory as by applying the hydrothermomechanical treatment fibres of high self-bonding properties are produced.

The starting material can be obtained by mechanically disintegrating a composite material for example particl eboard to chips. A lignocellulose modification agent can be added, for example a metal hydroxide, an organic or inorganic acid, a salt, an oxide, an amine, ammonia or an aimonium salt. Also standard components of a bonding agent such as formaldehyde scavengers, catalysts and extenders can be added if additional bonding material is added. Thus the process can be carried possibly in the presence of 0.01 to 0.4% by weight of sodium sulphate alone or with 0.01 to 0.4% by weight sodium hydroxide. The original or disintegrated product can be treated with 0.01 to 0.4% by weight sulphuric acid.

The main advantage of the process is that fibres can be produced from waste particleboards in one step. Therefore, the process is totally different from the process of making medium density fibreboards from lignocellulosic materials, in which the lignocellulosic material is impregnated in the first step with water or chemicals at high temperature of about 150° C. to 179° C. and then defibrated in a. one or two disc refiner in the process described by the invention there is no necessity to treat the waste particleboards or the mechanical disintegration products therefrom at such a high temperature. Treatment with water at 50° C. under high shear mechanical attrition is sufficient to disintegrate particleboards to fibres of high self-bonding behaviour. It was found that though the particleboard disintegrated and converted to fibres, the resin degradation products still apparently cover the surface of the fibres. The resin on the surface of the fibre may be the main reason why the fibres do have high self-bonding properties. During the thermal treatment in, for example, a twin screw extruder the disintegration products of the recycled material can be collected or left on the fibres to further enhance bondability.

The resulting hydrothermally treated material is preferably rebonded with the same adhesive as the recycled material. Typical resin bonding materials which can be used include urea-foremaldehyde resins (UF-resins), melamine-urea-formaldehyde resins (MUF-resins), melamine resins (MF-resins), phenol-formaldehyde resins (PF-resins), resorcinol-formaldehyde resins (RF-resins), tannin-formaldehyde resins (TF-resins), polymeric isocyanate binders (PMDI) and mixtures thereof. The resins can be added in the amount of 5-15% based on dry lignocellulose material.

It is also one of the embodiments of this invention to mix the recycled material with the binder mixture already in the high shear machine. UF, MUF, MF, PF, RF and TF resins can be employed for this purpose. In the case of amino resins, the adhesive can be added in a pre-catalysed or latently catalysed or non-catalysed state. A catalyst can also be added separately in the high shearing stage. Mixtures of resins like UF-polyisocyanates can also be used in the same way.

The addition of a sizing agent is not obligatory. However, it can be added if necessary, either in the high shear machine or separately. Other components of a standard glue mixture like formaldehyde scavengers, extenders etc., can also be added in the same way.

If residues of the resin bonding materials derived from the original recycled composite material are removed then additional bonding resin may have to be added in the final formation of the composite material but the invention is still advantageous in that one has the desirable capacity to utilise recycled materials which have hitherto proved difficult to recycle and form into new composite products.

Embodiments of the invention will now be illustrated in the following Examples.

### EXAMPLE 1

Waste particleboards were mechanically disintegrated and subaquitly treated in a twim screw extruder device by injecting water solutions of 0.01% H₂SO₄ or 1.0% NaOH at 100° C. and 1.0% NaOH at 50° C. The fibres produced were used for the production of 16mm lab scale boards after mixing with UF resin. The resin level employed was 10%, the pressing temperature was 1800C and the,press pressure was 35Kg/cm². Three replicate boards were produced in each case and their properties were subsequently determined. The average values of board properties are presented below:

| | 0.01% H₂SO₄ | 1.0% NaOH | 1.0% NaOH |
|---|---|---|---|
| | 100° C. | 100° C. | 50° C. |
| IB, N/mm² | 0.21 | 0.29 | 0.46 |
| MOR, N/mm²² | 12.7 | 10.1 | 13.1 |
| 24 h swell, % | 22.5 | 20.4 | 23.5 |
| HCHO, mg/100 g board | 21.4 | 13.5 | 16.3 |

The formaldehyde (HCHO) emission was determined by using the Perforator method.

As it can be seen from the above test, the treatment with NaOH solution gave the best results. The treatment at 50° C. provided an improvement of the Internal Bond strength (IB) and bending strength (Modulus of Rupture, MOR) values, but increased the swell and formaldehyde emission values. The treatment with NaOH at 100° C., gave better results.

### EXAMPLE 2

Wood chips and particleboards produced from them were. separately treated in a twin screw extruder device

| | Resin | | | HCHO | 24 h |
|---|---|---|---|---|---|
| | level | IB | MOR | mg/100 g | swell |
| | % | N/mm² | N/mm² | board | % |
| Wood chips | 0 | 0.05 | 5.3 | 1.3 | 121.6 |
| | 2 | 0.13 | 7.5 | 5.0 | 70.1 |
| | 4 | 0.17 | 8.0 | 6.0 | 60.2 |
| | 6 | 0.23 | 11.6 | 8.3 | 47.7 |
| | 8 | 0.29 | 13.3 | 10.5 | 35.3 |
| Particleboard | 0 | 0.07 | 6.5 | 10.8 | 88.5 |
| | 2 | 0.22 | 8.5 | 9.7 | 68.2 |
| | 4 | 0.33 | 9.2 | 9.6 | 56.5 |
| | 6 | 0.35 | 12.3 | 10.2 | 41.4 |
| | 8 | 0.41 | 18.4 | 15.0 | 28.1 |

by injecting a water solution of 0.04% H₂SO₄ at 100° C. 8Usn lob scale boards were produced from their fibres using 0, 2, 4, 6 and 8%of UF resin. The rest production parameters were the same as above. The average values of board propoerties are presented in the following table:

From the results of the above table, it is obvious that a significant reduction in resin consumption can be achieved by using fibres produced from waste particleboards treated according to the processm of the invention.

1. A method for producing fibrous or particulate material for manufacture of composite materials from recycled composite material wherein the fibrous or particulate recycled composite material is subjected to treatment with water or steam at 40° to 120° C. and simultaneously or subsequently subjected to a high shear treatment.

2. A process of forming a composite material by subjecting the fibrous or particulate material according to claim 1 to heat and pressure in the presence of a resin bonding agent.

3. A modification of the process of claim 2 in which the final composite material is formed without addition of bonding resin or with less bonding resin than might be normally employed for the formation of the desired composite having regard to the amount of fibrous or particulate material utilised.

4. A method according to claim 1 in which the hydrothermal treatment is at a temperature of 50C to 120° C.

5. A method according to any one of claims 1 to 4 in which the treatment with high shear is in a twin screw extruder.

6. A method according to any one of claims 1 to 5 in which a waste composite board is mechanically disintegrated to chips before the hydrothermal treatment.

7. A method according to any one of claims 5 or 6 wherein waste composite boards or disintegration products thereof are treated with 0.01-0.4% sulphuric acid as a catalyst.

8. A method according to either of claims 6 or 7 wherein the waste composite boards are disintegrated in the presence of 0.01-0.4% sodium sulphite as a catalyst.

9. A method according to either of claims 6 or 7 wherein the waste composite boards are disintegrated in the presence of 0.01-0.4% by weight sodium sulphite and 0.01-0.4% by weight sodium hydroxide.
